(19) United States
(12) Patent Application Publication
(10) Pub. No.: US 2022/0222693 A1
(43) Pub. Date: Jul. 14, 2022

(54) METHOD OF DEMOGRAPHIC INFORMATION GENERATION FROM NAME

(71) Applicant: Qatar Foundation for Education, Science and Community Development, Doha (QA)

(72) Inventors: Jim Jansen, Doha (QA); Soon-gyo Jung, Doha (QA); Joni Salminen, Doha (QA)

(21) Appl. No.: 17/570,663

(22) Filed: Jan. 7, 2022

Related U.S. Application Data
(60) Provisional application No. 63/135,301, filed on Jan. 8, 2021.

(51) Int. Cl. G06Q 30/02; G06N 5/04

(52) U.S. Cl. CPC G06Q 30/0204; G06N 5/04

(57) ABSTRACT

A method and system for generating demographic information based on a name. The method includes providing at least one processor, connecting the processor to the network, providing a user interface and providing one or more processor-executable instructions to the processor. Additionally the method includes initiating communication of the at least one processor to retrieve information from a plurality of data sources to develop a predictive model. Developing a predictive model includes cleaning the information received from the plurality of data sources into data sets, transforming the information received from the plurality of data sources into a data string and tokenizing the data string. An individual's name is inputted to the processor using the user interface to generate information regarding the individual's name, based on the predictive model. The generated information is an age, a gender and a nationality of the individual associated with the individual name.

### CROSS-REFERENCE TO RELATED APPLICATIONS

The present application claims priority to and the benefit of U.S. Provisional Application 63/135,301 filed on Jan. 8, 2021, the entirety of which is herein incorporated by reference.

### BACKGROUND

Gathering and analyzing consumer data is expensive and time-consuming. Additionally, marketing techniques such as market segmentation, require aggregating and examining an extensive amount of information about consumers. Marketers want to know, among other things, basic demographic information about consumers. This information consists of a consumer's age, gender and/or nationality. Basic demographic information about a consumer can be extremely useful to a marketer attempting to target a specific market with a product or service. This results in consumer research being an important aspect of any successful marketing strategy.

Consumer research driven by data aggregation and analysis using predictive models is a rapidly expanding field and thought to be the future of marketing. Predictive model based research utilizes computers trained with models to access data sets and compare an input to the data sets to predict information about the input. For example, Arc Pair Grammar (APG) is a modeling theory that analyzes syntax and linguistic structure of words and phrases to determine their relationship to other words or phrases. Several tools are currently available to search websites and social media accounts to aggregate information about a particular consumer. Once the information is gathered, statistical analysis and predictive models are used to generate specific insights from the information retrieved. However, typical consumer research tools currently available have several drawbacks. For instance, existing consumer research tools can be expensive which prevents wide ranging availability. Additionally, the predictive models utilized by existing tools are static in that they do not account for the changing preferences of naming in different countries. Another drawback is that existing research tools utilize global position system (GPS) data to determine nationality which can result in inaccurate data. In combination, these drawbacks result in a lack of accessibly to research tools, inaccurate information being generated and misguided insights being provided to the user of the tools.

Accordingly, there is a need for a consumer information research tool that is cost effective, intuitive and adaptive when generating and analyzing consumer data.

### SUMMARY

The present disclosure provides a new and innovative method for generating demographic information concerning a consumer based on analyzing the name of the consumer. An aim of the provided method is to allow for cost effective and accurate consumer research to better understand the demographic characteristics of a particular consumer. The method may be utilized to determine the age, gender and nationality, among other possible categories of demographic information, of a particular consumer based on an analysis of the consumer's name. The information generating method could be used by researchers, organizations and governmental agencies to better understand the demographic information of a particular individual simply based on the individual's name.

The present disclosure provides methods for generating demographic information which involve collecting data from multiple publicly available data sources, preparing the data collected by cleaning the data, transforming the data into data sets, developing predictive models that utilize the data sets and inputting a name into the models to determine demographic information regarding the inputted name. The disclosed method is carried out by utilizing at least one processor that is capable of executing processor-executable instructions. Additionally, the processor must also be capable of connecting to a network, for example the internet, in order to carry out the disclosed method. Finally, the method according to the present disclosure may utilize a user interface to allow the user to provide and receive information to/the from the processor.

The present disclosure encompasses several advantages over existing consumer research tools such as, utilizing publically available data sources and data sets to reduce costs. Additionally, the present disclosure utilizes data from online communities around the world which use a wide range of languages. This provides datasets with an increased statistical leverage and capacity to cover a diverse range of inputted names. Finally, the present disclosure provides the ability to complete cost effective and accurate consumer research even when the only thing known about a consumer is their name.

In light of the disclosure, and without limiting the scope of the invention in any way, in a first aspect of the present disclosure, which may be combined with any other aspect listed herein unless specified otherwise, a method for generating information in response to an input, includes providing at least one processor capable of connecting to a network, connecting the processor to the network thereby facilitating communication with at least one remote processor, providing a user interface in operable communication with the processor, where the user interface is used to input commands to the processor, providing one or more processor-executable instructions to the processor, where providing the processor-executable instructions causes the processor to execute the instructions in response to the input and initiating communication of the at least one processor, via the network, with the at least one remote processor such that the at least one remote processor retrieves information from a plurality of data sources and communicates the retrieved information to the at least one processor.

In another aspect of the present disclosure, which may be used in combination with any other aspect or combination of aspects listed herein, the method includes developing a predictive model utilizing the processor by processing the information received from the plurality of data sources, where developing the predictive model includes cleaning the information received from the plurality of data sources into data sets, transforming the information received from the plurality of data sources into a data string and tokenizing the data string.

In another aspect of the present disclosure, which may be used in combination with any other aspect or combination of aspects listed herein, the method includes inputting at least one individual's name to the processor using the user interface, generating information regarding the individual's name, via the processor, based on the predictive model and providing the generated information, where the generated information comprises an age, a gender and a nationality of the individual associated with the individual name inputted via the user interface.

In another aspect of the present disclosure, which may be used in combination with any other aspect or combination of aspects listed herein,

In another aspect of the present disclosure, which may be used in combination with any other aspect or combination of aspects listed herein, a plurality of a plurality of users' names are inputted to the processor via the user interface.

In another aspect of the present disclosure, which may be used in combination with any other aspect or combination of aspects listed herein, the plurality of data sources are selected from the group of websites, social media accounts, databases, and publicly available government databases.

In another aspect of the present disclosure, which may be used in combination with any other aspect or combination of aspects listed herein, the user interface is selected from the group of a graphical user interface, an auditory user interface and a virtual user interface.

In another aspect of the present disclosure, which may be used in combination with any other aspect or combination of aspects listed herein, the method is simultaneously performed by multiple users on a plurality of remote processors connected to a network.

In another aspect of the present disclosure, which may be used in combination with any other aspect or combination of aspects listed herein, the computer-implemented method includes providing at least one processor-executable instruction to a processor, where providing the processor-executable instructions causes the processor to execute the instructions in response to an input, initiating communication of the at least one processor, via the network, with the at least one remote processor such that the at least one remote processor retrieves information from a plurality of data sources and communicates the retrieved information to the at least one processor, developing a predictive model utilizing the processor by processing the information received from the plurality of data sources, wherein developing the predictive model includes cleaning the information received from the plurality of data sources into data sets, transforming the information received from the plurality of data sources into a data string and tokenizing the data string.

In another aspect of the present disclosure, which may be used in combination with any other aspect or combination of aspects listed herein, the computer-implemented method includes inputting at least one individual's name to the processor using the user interface, generating information regarding the individual's name, via the processor, based on the predictive model and providing the generated information, wherein the generated information comprises an age, a gender and a nationality of the individual associated with the individual name inputted via the user interface.

In another aspect of the present disclosure, which may be used in combination with any other aspect or combination of aspects listed herein, a plurality of users' names are inputted to the processor via the user interface.

In another aspect of the present disclosure, which may be used in combination with any other aspect or combination of aspects listed herein, the plurality of data sources are selected from the group of websites, social media accounts, databases, and publicly available government databases.

In another aspect of the present disclosure, which may be used in combination with any other aspect or combination of aspects listed herein, the user interface is selected from the group of a graphical user interface, an auditory user interface and a virtual user interface.

In another aspect of the present disclosure, which may be used in combination with any other aspect or combination of aspects listed herein, the method is simultaneously executed by multiple users on a plurality of remote processors connected to a network.

In another aspect of the present disclosure, which may be used in combination with any other aspect or combination of aspects listed herein, an information generation system includes at least one processor capable of connecting to a network, at least one remote processor capable of connecting to the network, a user interface operatively coupled to the processor, the interface configured to receive an input, a memory device storing processor-executable instructions, wherein the processor-executable instructions cause the processor to initiate communication of the at least one processor, via the network, with the at least one remote processor such that the at least one remote processor retrieves information from a plurality of data sources and communicates the retrieved information to the at least one processor, develop a predictive model utilizing the processor by processing the information received from the plurality of data sources, wherein developing the predictive model includes, clean the information received from the plurality of data sources into data sets, transform the information received from the plurality of data sources into a data string, tokenize the data string, receive an input of at least one individual's name using the user interface, generate information regarding the individual's name, via the processor, based on the predictive model and provide the generated information, wherein the generated information comprises an age, a gender and a nationality of the individual associated with the individual name inputted via the user interface.

In another aspect of the present disclosure, which may be used in combination with any other aspect or combination of aspects listed herein, a plurality of a plurality of users' names are inputted to the processor via the user interface.

In another aspect of the present disclosure, which may be used in combination with any other aspect or combination of aspects listed herein, the plurality of data sources are selected from the group of websites, social media accounts, databases, and publicly available government databases.

In another aspect of the present disclosure, which may be used in combination with any other aspect or combination of aspects listed herein, the user interface is selected from the group of a graphical user interface, an auditory user interface and a virtual user interface.

In another aspect of the present disclosure, which may be used in combination with any other aspect or combination of aspects listed herein, the system is simultaneously performed by multiple users on a plurality of remote processors connected to a network.

### BRIEF DESCRIPTION OF THE DRAWINGS

FIG. 1 illustrates a flow diagram of a system performing the presently disclosed method, according to an embodiment of the present disclosure.

FIG. 2 illustrates a flow chart of the different processes of the presently disclosed method, according to an embodiment of the present disclosure.

### DETAILED DESCRIPTION

The present disclosure provides a method for generating demographic information by analyzing a person's name using data sets and predictive modeling. The provided method enables cost effective and accurate data generation for a wide range of names from various countries. Demographic information about a particular individual is extremely insightful to an organization marketing a product. This information allows organizations to generalize the purchasing preferences and habits of a consumer. Once general demographic information is known about a consumer, an organization can provide a better experience for the consumer by narrowly tailoring the marketing directed to the consumer.

In an embodiment, the disclosed method is used to determine the gender of a person by analyzing their name. Gender determination is much easier than for other demographic attributes as its dichotomy characteristic and trends for female and male exist globally. There are also ways to determine gender based on online community users' user name, not given or family name, as there might be some popular words or patterns for each gender. There can be other aspects in using special characters also.

In another embodiment, the disclosed method is used to determine the age of a person by analyzing their name. Age determination can be difficult even though there are trends of naming in certain countries as a result of trends changing quickly or slowly or every decade. To make higher accuracy age determination, online users' photos, posts, and texts would be helpful even though it may be expensive to do so.

In another embodiment, the disclosed method is used to determine the nationality of a person by analyzing their name. To determine the country information, the name string must include the family name if the name is popular globally or in certain culture like European culture or Arabic culture. The other way to determine the country information accurately would be utilizing the name string's language. Detecting language can be also challenging as the name string is short in general and can include multiple languages as the disclosed method aims to use online community users who are likely to use multiple languages to present their name to others. Another challenge can be cultural understanding. One cannot know each country's name convention and its naming paradigm. To overcome this challenge, a larger number of names with demographic information is required by the presently disclosed method.

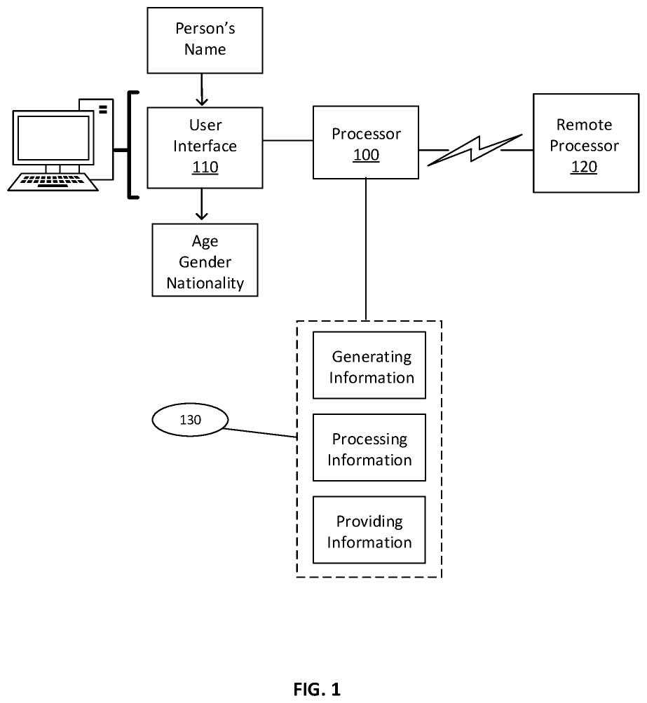

Referring to FIG. 1, in an embodiment, the method for generating demographic information based on a person's name includes providing at least one processor 100 capable of connecting to a network and connecting the processor to a network facilitating communication with at least one remote processor 120. In an embodiment, the method includes providing a user interface 110 in operable communication with the processor 100. The user interface 110 may be used to input commands to the processor. In an embodiment, the user interface 110 is a graphical user interface (GUI). For example, text-based user interfaces such as a keyboard may be employed. In an additional embodiment, virtual or audio based user interfaces may be employed.

In an embodiment, the presently disclosed method includes providing one or more processor-executable instructions 130 to the processor 110. The processor-executable instructions 130 causes the processor 110 execute the instructions 130 in response to an input. For example, the processor-executable instructions 130 may be provided via the user interface 110 or via the network connection originating from a remote processor 120. In an embodiment, the method includes inputting at least one input to the processor 100 using the user interface 110. The input may be a person's name or a plurality of names. In an embodiment, the input is provided via the user interface 110 or via the network connection originating from a remote processor 120.

In another embodiment, the presently disclosed method is simultaneously carried out by multiple users on a plurality of remote processors connected to a network.

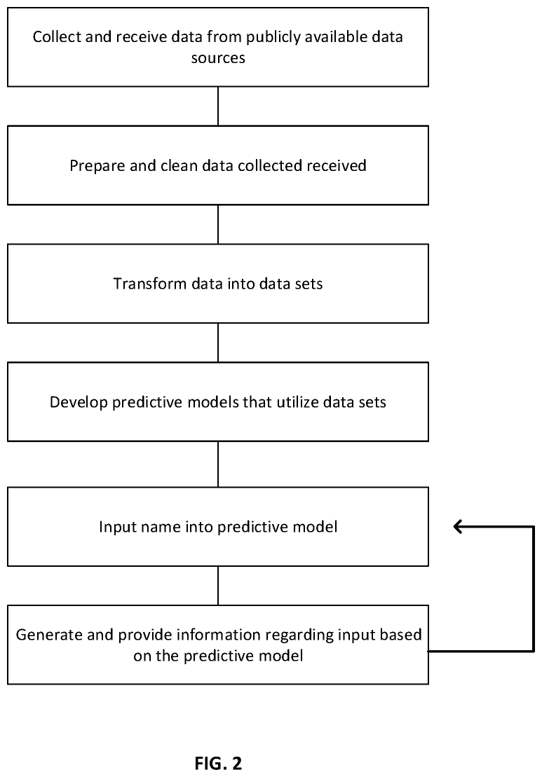

In an embodiment, the method includes initiating communication with at least one remote processor via a network to receive information from the plurality of data sources. In an embodiment, the information received is used to develop predictive models to generate information regarding the input, a person's name that is based on comparing the input to a plurality of data sources. Referring to FIG. 2, the presently disclosed method first involves gathering and aggregating demographic data regarding specific names from a variety of public sources on the internet. In an embodiment, the plurality of data sources may be websites, social media accounts, databases and/or publicly available government databases.

Data Collection

In an embodiment, Wikidata is used to collect data items consisting of Wikidata ID, given name, family name, birth year, gender, country code (ISO 3166), and written language in Wiki for 193 countries in different languages. Table 1 illustrates the data collected from Wikidata regarding a specific name.

| Wikidata ID | language | given name | family name | birth year | gender | country code |
|---|---|---|---|---|---|---|
| Q1000006 | de | Florian | Eichinger | 1971 | male | DE |
| Q1000006 | da | Florian | Eichinger | 1971 | male | DE |
| Q1000006 | en | Florian | Eichinger | 1971 | male | DE |
| Q1000006 | gsw | Florian | Eichinger | 1971 | male | DE |
| Q11461936 | ryu | Q6782794 | Q947991 | 1953 | male | JP |
| Q6152677 | en | Jane | Rogers | 1952 | female | GB |

In another embodiment, demographic information is collected from InterPals. InterPals asks all users for full name (as InterPals.net does not have separated columns for given name and family name), birthday, gender, and hometown and current city/country codes (Alpha-2 code, ISO 3166). The basic demographic information is displayed on the user's profile page. Using Python Scrapy, multiple proles are collected. Table 2 illustrates data collection including a hometown country code.

TABLE 2
Sample InterPals.net users

| full_name | gender | age | hometown | current | country_code |
|---|---|---|---|---|---|
| Kate | female | 30 | RU | KR | RU |
| Emre | male | 21 | — | TR | TR |
| Masia | female | 31 | — | RU | RU |

In another embodiment, demographic information is collected from Speaky.com, a free language exchange app that helps people find language partners worldwide. Javascript is used for the data collection semi-manually from the web service via a web browser developer console. A plurality of users are collected consisting of birth date, gender (as numeric −1 for male, 2 for male), given name, family name, native language IDs of the service, country and country code (Alpha-3 code, ISO 3166). The country code, gender and birth date are converted to corresponding values (Country code to Alpha-2 code, Numeric gender to male and female, and birth date to age). Table 3 illustrates data collection including a country code and native languages based on an input name.

TABLE 3
Sample Speaky.com users

| given_name | family_name | gender | birth_date | country | country code | native languages |
|---|---|---|---|---|---|---|
| Eduardo | Iserhardt | 1 | 1979 Dec. 15 | Brasil | BRA | [5] |
| Dewi | Wulandari | 2 | 2001 Feb. 9 | — | — | [52] |
| Soufiane | Elhami | 1 | 1996 Apr. 25 | United States | USA | [6, 3] |
| Mané | Manduka | 1 | 1967 Oct. 9 | Mexican | — | [2] |
| Alex | Dobrosolets | 1 | 1991 Jul. 29 | — | — | [12] |

In another embodiment, demographic information is gathered from Goodreads.com. Using Python Scrapy, a plurality of users are collected. The collected information of users is given name, full name and details from the user profile page. Commonly used data types are applied such as birth date/year to age, Alpha-2 country code of ISO 3166. Table 4 illustrates data collection including specific details based on an input name.

TABLE 4
Sample goodreads.com users

| given_name | full_name | details |
|---|---|---|
| Jen | Jen | Age 35 |
| Jeremy | Jeremy Porter | Male, Bridgewater, NS, Canada |
| Kim | Kim Gauger | Age 45, Female, Sebring, FL |
| Lisa Cohen | Lisa Cohen | Middlebury, VT |
| Ariane | Ariane | Ariane hasn't added any details yet. |

In an embodiment, the presently disclosed method includes extracting only necessary attribute information regarding names from a plurality of data sources. The extracted necessary attributes from goodreads.com are shown in Table 5.

TABLE 5
Extracted necessary attributes from goodreads.com users

| full_name | given_name | family_name | age | gender | country code |
|---|---|---|---|---|---|
| Jen | Jen | — | 35 | — | — |
| Jeremy Porter | Jeremy | Porter | — | Male | CA |
| Kim Gauger | Kim | Gauger | 45 | Female | US |
| Lisa Cohen | — | — | — | — | US |

Data Processing

In an embodiment, the presently disclose method involves developing a predictive model utilizing the processor by processing the information received from the plurality of data sources. Still referring to FIG. 2, the raw demographic data that was collected according to the disclosed method must be prepared and processed in order for the data to be used for statistical analysis and predictive modeling. In an embodiment, data collected from public sources must be cleaned. The data cleaning process can include: removing unnecessary information (email address, URL, name acronyms and/or emoji); transliterate the data into the Latin alphabet; modifying hyphenated names; handle prefix of family names; and replace all special letters with white-space. In an additional embodiment, data processing includes mitigating missing values (data) such as country code, given name, and family name. Additionally, data processing may include merging given names and family names and tokenizing names. In an embodiment, some given and family names consist of multiple name tokens. In that instance, the name tokens are separated to corresponding number of rows having the same demographic information for each name token. After tokenizing given names and unique given names data is created (GIVEN NAMES dataset).

Other data cleaning and processing techniques known to an ordinarily skilled artesian are also contemplated by the presently disclosed method.

Still referring to FIG. 2, the presently disclosed method next involves transforming the data that was collected. In an embodiment, three datasets are created for the further demographic mapping. NAME COUNTRY is to decide the country for the given name tokens. Table 6 illustrates the NAME COUNTRY data set.

TABLE 6
Some rows of NAME_COUNTRY dataset

| name | country_code | frequency | scaled_frequency | is_family_name |
|---|---|---|---|---|
| Avneet | IN | 21 | 0.777832 | False |
| Nattharika | TH | 15 | 1.000000 | False |
| Dina | HU | 15 | 0.005836 | False |
| Emerald | NG | 11 | 0.074829 | True |
| Soy | TR | 30 | 0.280273 | True |
| Bobo | DZ | 25 | 0.092224 | False |
| Seibert | DE | 12 | 0.226440 | True |
| Seibert | US | 37 | 0.698242 | True |
| Omnia | SD | 14 | 0.027512 | False |
| Yessine | TN | 18 | 0.750000 | False |

NAME COUNTRY GENDER is utilized for mapping gender of a given name token and a determined country code from NAME COUNTRY. Then, the determined country code and gender are used to decide the age using NAME COUNTRY GENDER AGE. Table 7 illustrates the NAME COUNTRY GENDER data set.

TABLE 7
Some rows of NAME_COUNTRY_GENDER dataset

| name | country_code | F_fre. | M_fre. | F_pro. | M_pro. | frequency | gender |
|---|---|---|---|---|---|---|---|
| Yoko | JP | 268 | 9 | 0.967285 | 0.032501 | 277 | female |
| Khalid | EG | 1 | 133 | 0.007462 | 0.992676 | 134 | male |
| Pal | HU | 7 | 65 | 0.097229 | 0.902832 | 72 | male |
| Wong | HK | 58 | 37 | 0.610352 | 0.389404 | 95 | female |
| Tone | NO | 90 | 1 | 0.988770 | 0.010986 | 91 | female |
| Toan | VN | 5 | 77 | 0.060974 | 0.938965 | 89 | male |
| Amine | DE | 1 | 68 | 0.014496 | 0.985352 | 69 | male |
| Hamouda | all | 3 | 99 | 0.029419 | 0.970703 | 102 | male |
| Robert | BR | 2 | 166 | 0.011902 | 0.988281 | 168 | male |
| Oezge | TR | 603 | 9 | 0.985352 | 0.014709 | 612 | female |

In an embodiment, NAME COUNTRY, NAME COUNTRY GENDER, NAMES are used to create NAME COUNTRY GENDER AGE dataset. This dataset is utilized to map age for a name, country, and gender. For example, the dataset consists of five columns: name, country code, gender, median age, and frequency. To decide age for a name, country, and gender, median age is used. Table 8 provides some samples of the dataset.

TABLE 8
Some rows of NAME_COUNTRY_GENDER_AGE dataset

| name | country_code | gender | median_age | frequency |
|---|---|---|---|---|
| Edwin | CO | male | 31 | 216 |
| Issam | DZ | male | 27 | 136 |
| Oezguer | TR | male | 26 | 767 |
| Sasha | US | female | 29 | 141 |
| Radim | CZ | male | 32 | 101 |
| Aylin | TR | female | 25 | 284 |
| Kate | UA | female | 23 | 1,104 |
| Ron | CA | male | 67 | 224 |

Developing Predictive Models

Still referring to FIG. 2, the presently disclosed method next involves developing demographic mapping models. In an embodiment, the model receives a name string then returns mapped demographic information. The name string first gets cleaned and tokenized when it composes multiple name tokens, then it is used to determine the country origin of the names string. If country code is determined, then gender and age are decided sequentially. Before mapping the demographic for a given name string, the given name string gets cleaned using the same steps of the cleaning section. If the given text consists of hyphen then the mapping would be proceeded with removed hyphen and with white spaced replaced hyphen. The cleaned given name string is tokenized by white space for the demographic mapping.

In an embodiment, to decide the country for the name tokens, NAME COUNTRY and the following Algorithm 1 are used:

Algorithm 1: Country determination

| | |
|---|---|
| 1 | algorithm get_country(name_tokens): |
| 2 | name_country = NAME_COUNTRY.concatenate(name_tokens) |
| 3 | name_country.add_mean_scaled_frequency() |
| 4 | top_row = name_country.get_top row_by_mean_scaled_frequency() |
| 5 | return top_row |

First, the algorithm retrieves the rows having the name tokens and concatenates them with identical name tokens along the country code. From this, the rows of not shared country code are discarded. Then, it calculates the mean for scaled frequency values of each country code corresponding row and add as a new column. Third, the top row having higher mean scaled frequency is selected. Finally, the algorithm returns the top row. The name tokens might exist in NAME COUNTRY partially or not exist at all, then the algorithm returns partially retrieved name tokens' top row or nothing. Table 9 illustrates name tokens corresponding concatenated NAMVIE COUNTRY's rows with calculated mean of scaled frequency over each row.

TABLE 9

| country | jim | | | bernard | | | jansen | | | mean.scaled |
|---|---|---|---|---|---|---|---|---|---|---|
| code | freq. | scaled_freq. | is_fam. | freq. | scaled_freq. | is_fam. | freq. | scaled_freq. | is_fam. | _freq. |
| AR | 3 | 0.000714 | False | 5 | 0.001638 | True | 1 | 0.002268 | True | 0.001540 |
| AU | 110 | 0.026169 | False | 24 | 0.007866 | False | 13 | 0.029480 | True | 0.021179 |
| BE | 7 | 0.001665 | False | 36 | 0.011803 | False | 4 | 0.009071 | True | 0.007511 |
| BR | 8 | 0.001903 | True | 21 | 0.006882 | False | 10 | 0.022675 | True | 0.010490 |
| CA | 324 | 0.077087 | False | 121 | 0.039673 | False | 9 | 0.020401 | True | 0.045746 |
| CH | 6 | 0.001428 | True | 46 | 0.015076 | False | 2 | 0.004536 | True | 0.007015 |
| DE | 18 | 0.004280 | False | 24 | 0.007866 | False | 64 | 0.145142 | True | 0.052399 |
| EC | 1 | 0.000238 | False | 2 | 0.000656 | True | 1 | 0.002268 | False | 0.001054 |
| ES | 4 | 0.000951 | True | 2 | 0.000656 | False | 1 | 0.002268 | True | 0.001292 |
| FI | 6 | 0.001428 | False | 2 | 0.000656 | False | 1 | 0.002268 | True | 0.001451 |
| FR | 38 | 0.009041 | False | 1537 | 0.503906 | False | 10 | 0.022675 | True | 0.178589 |
| GB | 469 | 0.111572 | False | 116 | 0.038025 | False | 7 | 0.015869 | True | 0.055176 |
| ID | 13 | 0.003092 | True | 27 | 0.008850 | False | 14 | 0.031738 | True | 0.014557 |
| IN | 15 | 0.003569 | False | 8 | 0.002623 | True | 1 | 0.002268 | True | 0.002821 |
| IT | 5 | 0.001189 | False | 13 | 0.004261 | True | 1 | 0.002268 | True | 0.002573 |
| KE | 10 | 0.002378 | False | 33 | 0.010818 | False | 1 | 0.002268 | False | 0.005154 |
| KR | 19 | 0.004520 | True | 1 | 0.000328 | False | 3 | 0.006802 | True | 0.003883 |
| MY | 15 | 0.003569 | False | 7 | 0.002295 | True | 1 | 0.002268 | False | 0.002710 |
| NL | 29 | 0.006897 | False | 15 | 0.004917 | False | 151 | 0.342285 | True | 0.117981 |
| NZ | 34 | 0.008087 | False | 4 | 0.001311 | True | 4 | 0.009071 | True | 0.006153 |
| PH | 55 | 0.013084 | False | 40 | 0.013107 | False | 15 | 0.034027 | True | 0.020065 |
| RU | 14 | 0.003330 | False | 6 | 0.001966 | True | 1 | 0.002268 | False | 0.002522 |
| SE | 24 | 0.005711 | False | 4 | 0.001311 | False | 1 | 0.002268 | True | 0.003098 |
| SG | 11 | 0.002617 | True | 8 | 0.002623 | True | 2 | 0.004536 | False | 0.003258 |
| TH | 28 | 0.006660 | True | 3 | 0.000983 | True | 1 | 0.002268 | True | 0.003304 |
| TZ | 1 | 0.000238 | False | 9 | 0.002951 | True | 1 | 0.002268 | False | 0.001819 |
| US | 2,489 | 0.592285 | False | 399 | 0.130737 | False | 64 | 0.145142 | True | 0.289307 |
| ZA | 9 | 0.002140 | False | 22 | 0.007210 | False | 28 | 0.063477 | True | 0.0214277 |

In an embodiment, once the given name tokens are selected, NAME COUNTRY GENDER, country code, and given name tokens are forwarded to the following Algorithm 2 to determine appropriate gender and additional information.

Algorithm 2: Gender determination

| 1 | algorithm get_gender(country_code, given_name_tokens): | |
|---|---|---|
| 2 | name_country_gender = NAME_COUNTRY_GENDER.concatenate( | |
| | | country_code, |
| | | given_name_ tokens) |

| | |
|---|---|
| 3 | name_country_gender.add mean_proportion_for both_genders() |
| 4 | gender = name_country_gender.get_highly_proportioned_gender() |
| 5 | proportion = name_country_gender.get_mean_proportion(gender) |
| 6 | frequency = name_country_gender.get_sum_of_frequency(gender) |
| 7 | return gender, proportion, frequency |

First, the algorithm finds the rows corresponding to country code and gives name tokens from NAME COUNTRY GENDER and concatenates the rows along the given name tokens. The algorithm calculates the mean proportion value for both genders and ads as an additional row. Then, the algorithm chooses the higher proportioned gender as a corresponding gender to the country code and given name tokens. Eventually, the algorithm returns the selected gender and the gender's proportion and frequency. Table 10 illustrates given name tokens corresponding concatenated NAME COUNTRY GENDER's rows along the two sets of given names tokens.

TABLE 10

| | jim | soon | gyo | mean |
|---|---|---|---|---|
| female_frequency | 8 | 37 | 5 | — |
| male_frequency | 1457 | 25 | 2 | — |
| female_proportion | 0.00546265 | 0.59668 | 0.714355 | 0.655273 |
| male_proportion | 0.994629 | 0.40332 | 0.285645 | 0.344482 |
| frequency | 1465 | 62 | 7 | — |
| gender | male | female | female | — |

In an embodiment, age determination is a simple retrieval from NAME COUNTRY GENDER AGE by using the following Algorithm 3.

Algorithm 3: Age determination

| 1 | algorithm get_age(country_code, gender, given_name_tokens): | |
|---|---|---|
| 2 | name_country_gender_age = NAME_COUNTRY_GENDER_AGE.concatenate( | |
| | | country_code, gender, |
| | | given_name_tokens) |

| | |
|---|---|
| 3 | median_age = name_country_gender_age.get_mean_median_age() |
| 4 | frequency = name_country_gender_age.get_sum_frequency() |
| 5 | return median_age, frequency |

Algorithm 3 simply retrieves corresponding rows for given name tokens, country code and gender and concatenates them. Then, the algorithm calculates mean value of median ages and total frequency of frequencies for given name tokens. Finally, the algorithm returns mean of median age and sum of frequency. For country, gender, and age, the module returns cleaned name, whether the name tokens are fully matched or not, country mapping result, gender mapping result, and age mapping result. For country, name tokens, country code, confidence (mean value of scaled frequency), and the name tokens classified as family name. For gender, the used name tokens and two determined genders (in the country and in all countries) are included. Each determined gender has confidence (the mean proportion of the determined gender) and the gender's frequency (how many times the name tokens appear in the NAMES as the gender). For age, the age has the used name tokens for age determination and two age values with age range (i.e. general age ranges, 13-17, 18-24, 25-34, 35-44, 45-54, 55-64, and 65+) and frequency of the name within the age range. Table 11 illustrates given name tokens corresponding concatenated NAME COUNTRY GENDER AGE's rows along the two sets of given names tokens.

TABLE 11

| | jim | soon | gyo |
|---|---|---|---|
| country_code | US | KR | KR |
| gender | male | female | female |
| median_age | 63 | 30 | 26 |
| frequency | 1,454 | 37 | 5 |

Additionally, for tagging the status of family name, FAMILY NAMES is used. There can be family names which would be popular given names even they are entered by online community users or distinguished as family names. To distinguish which family name is used as given name in a certain country popularly, FAMILY NAMES and proportion of both gender for a particular name in a particular country are used. When either gender proportion is more than 0.8, then the family name of a particular country is excluded from FAMILY NAMES. From this, FAMILY NAMES holds only most likable family names. Then, names of NAMES appearing in FAMILY NAMES are tagged as family names.

Generating Information Regarding the Input

In an embodiment, still referring to FIG. 2, the presently disclosed method includes inputting at least one input to the processor using the user interface and generating information regarding the input based on the predictive model.

In an embodiment, the method includes providing the generated information via the user interface. For example, the generated information includes a plurality of attributes regarding the input. The attributes may be one of gender, age and/or nationality when the input is a person's name.

In an embodiment, a plurality online tools may be utilized to analyze the prediction model of the presently disclosed method. For example, Table 12 illustrates five online services for gender and country determination.

TABLE 12
Five online services for gender and country determination

| | Genderize.io | Nationalize.io | NameAPI | Gender API | NamSor |
|---|---|---|---|---|---|
| Handle full names | no | no | yes | yes | yes |
| Determine gender | yes | no | yes | yes | yes |
| Determine country | no | yes | no | no | yes |
| Monthly free requests | 30,000 | 30,000 | 2,500 | 500 | 5,000 (gender) |
| for full name | | | | | 500 (country) |
| Pricing for | 9$ | 9$ | 470$ (Monthly) | 79.24$ (Monthly) | 130$ (gender) |
| 100,000 full names | | | 706$ (one-time) | 99.30$ (one-time) | 999$ (country) |

Genderize.io13 is a simple API to predict the gender of a person given their name. Nationalize.io14 predicts the nationality of a person given their name. Both APIs are free for up to 1,000 names per day. Genderize.io provides probability and count, presenting how many data entries used to return the gender. Nationalize.io returns with three most likable countries with probability. Both APIs only takes a given name not full name. Name API is a free and paid service platform to work with names. It provides functionality in the form of web services to do name parsing, name genderizing, name matching, name formatting, and more. This API handles a full name. This API returns many likable results with likeliness and confidence values. NamSor is a classifier of personal names by gender, country of origin, or ethnicity. The API returns genderScale for gender and score for gender and country, genderScale ranges from −1 to 1 to reflect that the name is male or female, score qualifies the trust-worthiness of the determination. For country, the API provides the determined country code and the alternative country codes as well. Table 13 illustrates a summary of the prediction results from different tools for different demographic attribute. The presently disclosed method (Name2GAN) provides better accuracy than the other tools for gender and country determination.

TABLE 13

| | | | | Accuracy | Accuracy |
|---|---|---|---|---|---|
| Tool | Attribute | Predicted | Shared | (Predicted) | (Shared) |
| nationalize.io | country | 7,857 | 7,802 | 0.256 | 0.256 |
| Name2GANGivenName | country | 9,383 | 7,802 | 0.512 | 0.517 |
| NamSor | country | 9,999 | 9,270 | 0.351 | 0.35G |
| Name2GAN | country | 9,271 | 9,270 | 0.562 | 0.562 |
| genderize.io | gender | 8,663 | 8,189 | 0.927 | 0.935 |
| Name2GANGivenName | gender | 9,023 | 8,189 | 0.944 | 0.949 |
| NameAPI | gender | 9,634 | 8,729 | 0.768 | 0.815 |
| GenderAPl | gender | 9,682 | 8,729 | 0.864 | 0.875 |
| NamSor | gender | 9,999 | 8,729 | 0.879 | 0.906 |
| Name2GAN | gender | 8,837 | 8,729 | 0.949 | 0.951 |

The column “Predicted” presents the number of name strings which determined its demographic attribute from a particular tool. Interestingly, NamSor returns determined demographic attribute for all the name strings. Only one name string could not get its result from NamSor as the name string has a slash the name string and the API gets a name string as URL path. The column “Shared” indicates there are certain amount of name strings received the prediction results from all the tools. Nationalize.io and genderize.io are separately classified as they get only given name as a name string. For country determination, the presently disclosed method determines the country information for the given name strings better than the other tools. Even NamSor returns all the name strings' country information, the accuracy for shared name strings with the presently disclosed method is 0.356. Nationalize.io determines less number of name strings than other tools and decides small number of name strings' country information correctly than the other tools (2,008 name strings). When it comes to gender decision, generally, all tools show higher accuracy than the accuracy of country determination. As Table 13 shows, even though the presently disclosed method determines less number (8,837) of full name strings than other tools, its accuracy is higher than other tools. In other words, the presently disclosed method is more reliable than other tools as it is better at giving proper gender than giving improper gender. The presently disclosed method can decide age of the given name string not like other tools. Among 10,000 users, 5,986 users have their age information and 5,377 users received their age determined by the presently disclosed method (42.5% users among 5,377 users got their age range determined correctly).

Without further elaboration, it is believed that one skilled in the art can use the preceding description to utilize the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

The invention is claimed as follows:

1. A method for generating information in response to an input, the method comprising:
providing at least one processor capable of connecting to a network;
connecting the processor to the network thereby facilitating communication with at least one remote processor;
providing a user interface in operable communication with the processor, wherein the user interface is used to input commands to the processor;
providing one or more processor-executable instructions to the processor, wherein providing the processor-executable instructions causes the processor to execute the instructions in response to the input;
initiating communication of the at least one processor, via the network, with the at least one remote processor such that the at least one remote processor retrieves information from a plurality of data sources and communicates the retrieved information to the at least one processor;
developing a predictive model utilizing the processor by processing the information received from the plurality of data sources, wherein developing the predictive model includes
cleaning the information received from the plurality of data sources into data sets,
transforming the information received from the plurality of data sources into a data string,
tokenizing the data string;
inputting at least one individual's name to the processor using the user interface;
generating information regarding the individual's name, via the processor, based on the predictive model; and
providing the generated information, wherein the generated information comprises an age, a gender and a nationality of the individual associated with the individual name inputted via the user interface.

2. The method of claim 1, wherein a plurality of a plurality of users' names are inputted to the processor via the user interface.

3. The method of claim 1, wherein the plurality of data sources are selected from the group of websites, social media accounts, databases, and publicly available government databases.

4. The method of claim 1, wherein the user interface is selected from the group of a graphical user interface, an auditory user interface and a virtual user interface.

5. The method of claim 1, wherein the method is simultaneously performed by multiple users on a plurality of remote processors connected to a network.

6. A computer-implemented method, comprising:
providing at least one processor-executable instruction to a processor, wherein providing the processor-executable instructions causes the processor to execute the instructions in response to an input;
initiating communication of the at least one processor, via the network, with the at least one remote processor such that the at least one remote processor retrieves information from a plurality of data sources and communicates the retrieved information to the at least one processor;
developing a predictive model utilizing the processor by processing the information received from the plurality of data sources, wherein developing the predictive model includes
cleaning the information received from the plurality of data sources into data sets,
transforming the information received from the plurality of data sources into a data string,
tokenizing the data string;
inputting at least one individual's name to the processor using the user interface;
generating information regarding the individual's name, via the processor, based on the predictive model; and
providing the generated information, wherein the generated information comprises an age, a gender and a nationality of the individual associated with the individual name inputted via the user interface.

7. The method of claim 6, wherein a plurality of users' names are inputted to the processor via the user interface.

8. The method of claim 6, wherein the plurality of data sources are selected from the group of websites, social media accounts, databases, and publicly available government databases.

9. The method of claim 6, wherein the user interface is selected from the group of a graphical user interface, an auditory user interface and a virtual user interface.

10. The method of claim 6, wherein the method is simultaneously executed by multiple users on a plurality of remote processors connected to a network.

11. An information generation system, the system comprising:
at least one processor capable of connecting to a network;
at least one remote processor capable of connecting to the network;
a user interface operatively coupled to the processor, the interface configured to receive an input;
a memory device storing processor-executable instructions, wherein the processor-executable instructions cause the processor to:
initiate communication of the at least one processor, via the network, with the at least one remote processor such that the at least one remote processor retrieves information from a plurality of data sources and communicates the retrieved information to the at least one processor,
develop a predictive model utilizing the processor by processing the information received from the plurality of data sources, wherein developing the predictive model includes,
clean the information received from the plurality of data sources into data sets,
transform the information received from the plurality of data sources into a data string,
tokenize the data string;
receive an input of at least one individual's name using the user interface;
generate information regarding the individual's name, via the processor, based on the predictive model; and
provide the generated information, wherein the generated information comprises an age, a gender and a nationality of the individual associated with the individual name inputted via the user interface.

12. The system of claim 11, wherein a plurality of users' names are inputted to the processor via the user interface.

13. The system of claim 11, wherein the plurality of data sources are selected from the group of websites, social media accounts, databases, and publicly available government databases.

14. The system of claim 11, wherein the user interface is selected from the group of a graphical user interface, an auditory user interface and a virtual user interface.

15. The system of claim 11, wherein the system is simultaneously performed by multiple users on a plurality of remote processors connected to a network.
